(19) United States
(12) Patent Application Publication
(10) Pub. No.: US 2019/0306944 A1
(43) Pub. Date: Oct. 3, 2019

(54) LED LAMP

(71) Applicant: SENGLED CO., LTD., Shanghai (CN)

(72) Inventors: Junshan LOU, Shanghai (CN); Jinxiang SHEN, Shanghai (CN)

(21) Appl. No.: 16/444,314

(22) Filed: Jun. 18, 2019

Related U.S. Application Data
(63) Continuation of application No. PCT/CN2017/095641, filed on Aug. 2, 2017.

(30) Foreign Application Priority Data
Dec. 29, 2016 (CN) 201611241967.4

(51) Int. Cl. H05B 33/08; H05B 37/02; H01F 27/30; F21V 23/04

(52) U.S. Cl. CPC H05B 33/0821; F21V 23/04; H01F 27/30; H05B 37/0272

(57) ABSTRACT

The present disclosure provides an LED lamp including one or more LED loads, a transformer, a wireless module, a control switch, and a resistor. The transformer includes a primary coil, a first secondary coil configured to power the one or more LED loads of the LED lamp, and a second secondary coil configured to power the wireless module. The resistor is connected in series with the control switch and then connected in parallel with at least one of the one or more LED loads. The wireless module is configured to send a connection signal to turn on the control switch during a turn-off process of the LED lamp.

### CROSS-REFERENCES TO RELATED APPLICATIONS

This application is a continuation application of PCT Patent Application No. PCT/CN2017/095641, filed on Aug. 2, 2017, which claims the priority to Chinese Patent Application No. 201611241967.4 filed on Dec. 29, 2016, the entire contents of both of which are incorporated herein by reference.

### FIELD OF DISCLOSURE

The present disclosure generally relates to the field of lighting technologies and, more particularly, relates to a Light Emitting Diode (LED) lamp.

### BACKGROUND

Intelligent home lighting is an important part of intelligent internet of things. More and more LED lamps are equipped with smart home functions such as wireless connection and lighting control by adding microprocessors and wireless modules. Due to the high cost-effective performance of a single-stage LED driving power supply solution, most of the current LED lamps use single-stage isolated power supply. In this single-stage isolated power supply solution, in order to ensure power supply stability of the wireless module and the microprocessor when the LED lamp is turned off and when other transient processes occur, an existing preferred solution is to add an auxiliary power supply to separately provide power to the wireless module and the microprocessor, but this solution leads to additional components and rising costs.

The disclosed LED lamp is directed to solve one or more problems set forth above and other problems.

### BRIEF SUMMARY OF THE DISCLOSURE

Embodiments of the present disclosure provide an LED lamp to ensure power supply stability to a wireless module when the LED lamp is extinguished and during other transient processes and at the same time have reasonable manufacture cost.

One aspect of the present disclosure provides an LED lamp. The LED lamp includes one or more LED loads, a transformer, a wireless module, a control switch, and a resistor. The transformer includes a primary coil, a first secondary coil configured to power the one or more LED loads of the LED lamp, and a second secondary coil configured to power the wireless module. The resistor is connected in series with the control switch and then connected in parallel with at least one of the one or more LED loads. The wireless module is configured to send a connection signal to turn on the control switch during a turn-off process of the LED lamp.

Another aspect of the present disclosure provides an LED lamp. The LED lamp includes an LED load, a transformer, a wireless module, a control switch, and a resistor. The transformer includes a primary coil, a first secondary coil, and a second secondary coil. The first secondary coil is configured to provide power to LED loads of the LED lamp, and the second secondary coil is configured to provide power to the wireless module. The resistor is configured to limit a supply current from the transformer during a turn-off process of the LED lamp. A first terminal of the resistor is connected to a high voltage side of the LED load and a second terminal of the resistor is connected to the wireless module.

The disclosed LED lamp includes a transformer and a wireless module that are connected to each other. The transformer includes a primary coil, a first secondary coil, and a second secondary coil. The first secondary coil is configured to provide power to LED loads of the LED lamp, and the second secondary coil is configured to provide power to the wireless module. The LED lamp also includes a resistor and other electronic elements to ensure power supply stability to the wireless module during a turn-off process of the LED lamp and other transient processes, and at the same time have reasonable manufacture cost.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions of this disclosure, the accompanying drawings will be briefly introduced below. Obviously, the drawings are only part of the disclosed embodiments. Those skilled in the art can derive other drawings from the disclosed drawings without creative efforts.

FIG. 1 illustrates a structural diagram of an LED lamp having a single-stage isolated power supply commonly used in the prior art;

FIG. 2 illustrates a structural diagram of an LED lamp consistent with the disclosed embodiments;

FIG. 3 illustrates a structural diagram of another LED lamp consistent with the disclosed embodiments;

FIG. 4 illustrates a structural diagram of another LED lamp consistent with the disclosed embodiments;

FIG. 5 illustrates a structural diagram of another LED lamp consistent with the disclosed embodiments;

FIG. 6 illustrates a structural diagram of another LED lamp consistent with the disclosed embodiments;

FIG. 7 illustrates a structural diagram of another LED lamp consistent with the disclosed embodiments.

### DETAILED DESCRIPTION

The technical solutions of the present disclosure will be described below together with the accompanying drawings. Obviously, the described embodiments are only part of, not all of the embodiments of this disclosure. Based on the disclosed embodiments, other embodiments obtained by those skilled in the art without creative efforts are within the protection scope of this disclosure.

FIG. 1 shows a structural diagram of the single-stage isolated power supply structure of an LED lamp commonly used in the prior art. As shown in FIG. 1, the LED lamp includes an LED load, a wireless module, a transformer T1, and an auxiliary power supply. The transformer includes a primary coil T1-A and a first secondary coil T1-B. The first secondary coil T1-B is configured to power the LED loads. The auxiliary power supply is configured to power the wireless module. The auxiliary power supply may be a rechargeable battery.

In the prior art, the wireless module and the microprocessor are separately powered by adding an auxiliary power supply, resulting in additional components and rising cost. The LED lamp provided in this disclosure is directed to solve at least the above problem.

The present disclosure will be further described in detail below with reference to the accompanying drawings.

In an exemplary LED lamp disclosed herein, the auxiliary power supply in the prior art is replaced by a second secondary coil T1-C which can also transfer energy from the primary circuit T1-A. When the LED lamp is turned on, a constant-voltage (CV) controller (or a constant-voltage constant-current controller) can control power supplied from the transformer T1 (e.g., connected to an external power supply such as a household AC supply) to a suitable voltage and/or current for the LED load so that the LED lamp is light up. The power of the wireless module is also supplied from the transformer T1. The first secondary coil T1-B is configured to power the LED loads, and the second secondary coil T1-C is configured to power the wireless module of the LED lamp. When the wireless module receives an instruction to turn off the LED lamp, an output voltage of the primary circuit T1-A is lowered (which subsequently lowers the voltage of the secondary circuit T1-B and the voltage supplied to the LED load) through the use of the constant-voltage (CV) controller (or a constant-voltage constant-current controller) until the LED load fail to conduct and is turned off. During the process of lowering the output voltage, an output voltage of the secondary circuit T1-C is also correspondingly lowered. Accordingly, the second secondary coil T1-C cannot provide a stable voltage to the wireless module during the period in which the LED lamp is turned off. To address this issue, the disclosed LED lamp provides an additional circuit component for stabilizing the power supplied to the wireless module during such transient process.

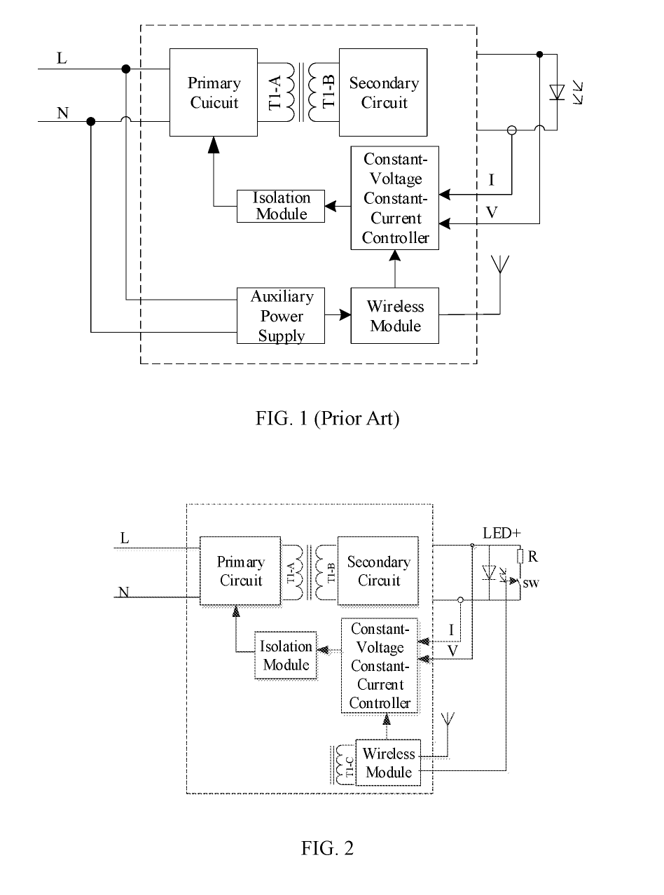

In an exemplary embodiment, as shown in FIGS. 2-7, the disclosed LED lamp includes at least one LED load, a wireless module, a transformer T1, and a circuit component for stabilizing power supplied to the wireless module during a transient process (e.g., a turn-off process of the LED lamp). The at least one LED load is configured to emit light when power is supplied. The wireless module is configured to establish wireless communication with a user terminal, receive a command from the user terminal through the wireless communication, and execute the command. The command may be directed to the LED load, such as turning on/off the LED load (i.e., turning the LED lamp on/off), adjusting brightness of the light emitted by the LED load, etc. For example, in response to a light-off command, the wireless module may send control signal(s) to other circuit components for implementing the command, such as lower the output voltage on the LED load, turn on a control switch, etc. The transformer T1 includes a primary coil T1-A, a first secondary coil T1-B, and a second secondary coil T1-C. The primary coil T1-A is included in the primary circuit. The first secondary coil T1-B is included in the secondary circuit. The first secondary coil T1-B is connected with the at least one LED load and is configured to power the at least one LED load. The second secondary coil T1-C is connected with the wireless module of the LED lamp and is configured to power the wireless module. The circuit component includes one or more low-cost electronic elements for stabilizing power supply to the wireless module during a turn-off process of the LED lamp and other transient processes, such as a resistor, a control switch, a diode, a Zener diode, a voltage comparator, etc. Unlike the LED lamp in the prior art as shown in FIG. 1, the circuit component is not an auxiliary power supply.

The disclosed LED lamp may further include a constant-voltage controller connected to the at least one LED load and the wireless module, and an isolation module connected in between the primary circuit (e.g., primary coil T1-A) and the constant-voltage controller. Any suitable isolation module for implementing single-stage isolated power supply in the existing technology may be applied in the disclosed LED lamp.

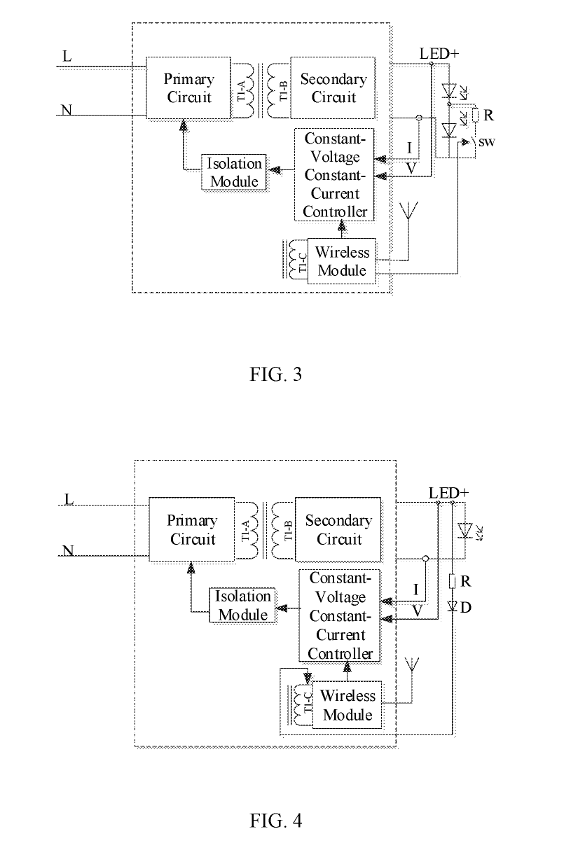

In some embodiments, the circuit component for stabilizing power supplied to the wireless module during a transient process includes a resistor R and a control switch SW. The resistor R is connected in series with the control switch SW and then connected in parallel with the at least one LED load. FIG. 2 and FIG. 3 illustrate two exemplary embodiments of such configuration. When the wireless module receives a light-off command (i.e., during a turn-off process of the LED lamp), a connection signal is sent to the control switch SW, so that the resistor R and the at least one LED load connected in parallel can shorten the saturation time of the voltage loop. Accordingly, the time that the second secondary coil T1-C cannot power the wireless module is shortened when the LED loads are turned off.

FIG. 2 shows a structural diagram of an LED lamp in one embodiment. FIG. 2 shows that the resistor R and all the LED loads are connected in parallel.

When the LED lamp is turned on, the control switch SW is at an off/open state, disconnecting the resistor R from the LED loads. When the wireless module receives a light-off command (e.g., from a user terminal), a turn-on signal is sent by the wireless module to the control switch SW. The control switch SW turns on (i.e., closed) so that the resistor R and all the LED loads are connected in parallel to shorten the saturation time of the voltage loop, which in turn shortens the time that the second secondary coil T1-C cannot power the wireless module while the LED loads is being turned off. The saturation time of the voltage loop can be modified by changing the resistance of the resistor R. Specifically, an output capacitance of the secondary circuit is very large, since the resistor R and the output capacitor at the first secondary coil T1-B (specific electrical components not shown) are connected in parallel, the time constant of the discharge is R*C. C is a large constant that cannot be changed, thus a smaller R (resistance) value can result in a smaller time constant. The output voltage can be lowered in a shorter amount of time so as to shorten the saturation time of the voltage loop. In some embodiments, when the control switch SW is turned on and the resistor R is connected to an output terminal of the LED lamp circuit, power consumption may be increased. To address this issue, the control switch SW is automatically turned off after being turned on for a preset period of time. The specific setting of the preset time period may be determined by experimental and theoretical analyses according to the required time for the output voltage to fall to a target value. After the required time for the output voltage to fall to the target value is passed, the wireless module may send a turn-off signal to the control switch SW to disconnect the resistor R from the circuit.

FIG. 3 shows a structural diagram of an LED lamp in one embodiment. FIG. 3 shows that the resistor R and part of the LED loads are connected in parallel. When the wireless module receives a light-off command, a turn-on/connection signal is sent to the control switch SW. The control switch SW is turned on so that the resistor R and the part of the LED loads is connected in parallel. Part of the LED loads are short-circuited so that the voltage on the high-voltage side of the LED loads drops rapidly (e.g., the resistance of resistor R is significantly lower than the LED load that it is parallelly connected to, such part of the LED loads can be considered as short-circuited). The resistor R is used to limit the discharge current, thereby shortening the saturation time of the voltage loop. The time that the second secondary coil T1-C cannot power the wireless module is shortened accordingly when the LED loads are turned off. The saturation time of the voltage loop can be modified by changing the resistance of the resistor R. Specifically, since the resistor R and the output capacitor are connected in parallel, the time constant of the discharge is R*C. C is a large constant that cannot be changed, thus a smaller R value can get a smaller time constant. The output voltage can be lowered in a shorter time so as to shorten the saturation time of the voltage loop. Further, because the control switch SW is in the on state and the resistor R is connected to the output terminal, thereby increasing unnecessary power consumption, the control switch SW is automatically turned off when being turned on for a preset period of time. The specific setting of the preset time period may be determined by experimental and theoretical analyses according to the required time for the output voltage to fall to the target value.

In some embodiments, the circuit component for stabilizing power supplied to the wireless module during a transient process includes a resistor R connected between the high voltage side of the LED load and the wireless module and a second electronic element (e.g., a diode, a control switch, a Zener diode, etc.). FIGS. 4-7 illustrate four exemplary embodiments of such configuration. For example, the disclosed LED lamp includes, besides the transformer T1 shown in FIG. 1, the resistor R. A first terminal of the resistor R is connected to a high voltage side of the LED load (e.g. directly) and a second terminal of the resistor R is connected to the wireless module (e.g., via the second electronic element). The resistor R is configured to limit the current from the power supply (e.g., the transformer) during the light-off process. When the wireless module sends a light-off command, the voltage of the high-voltage side of the LED load (marked as LED+ in FIGS. 4-7) is supplied to the wireless module.

FIG. 4 shows a structural diagram of an LED lamp in one embodiment. As shown in FIG. 4, the LED lamp includes a resistor R and a diode D connected in series with the resistor R. An anode of the diode D is connected to the second terminal of the resistor R, a cathode of the diode D is connected to the wireless module.

Specifically, when the LED load is turned on and the voltage on the high voltage side of the LED load is less than the supply voltage of the second secondary coil T1-C, the diode D is configured to prevent current backflow. When the wireless module sends a light-off command and the LED load is being turned off, the supply voltage of the second secondary coil T1-C drops rapidly, and the voltage on the high voltage side of the LED load drops slowly. As the voltage on the high voltage side of the LED load becomes greater than the supply voltage of the second secondary coil T1-C, the diode D is turned on, and the voltage on the high voltage side of the LED load powers the wireless module.

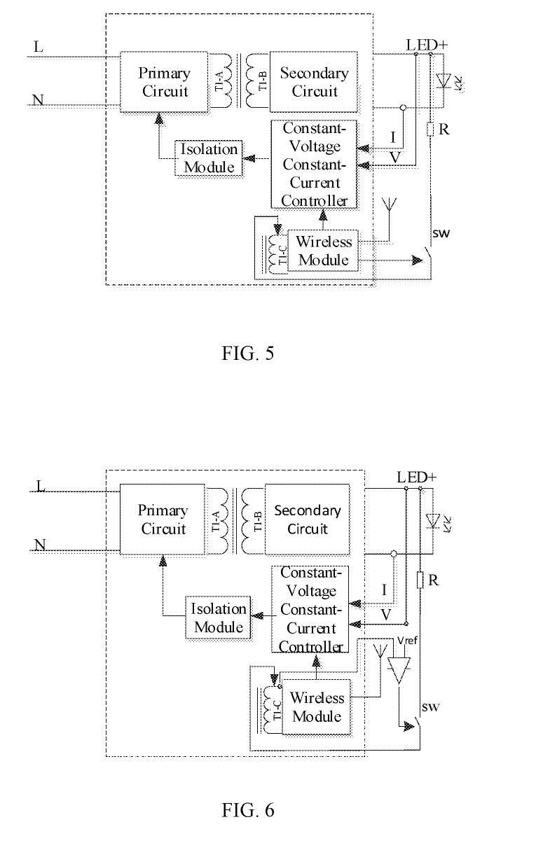

FIG. 5 shows a structural diagram of an LED lamp in one embodiment. As shown in FIG. 5, the LED lamp further includes a resistor R and a control switch SW connected in series with the resistor R. A first terminal of the control switch SW is connected with the second terminal of the resistor R, and a second terminal of the control switch SW is connected with the wireless module. The control switch is configured to turn on or off based on a control signal from the wireless module.

Specifically, when the LED load is turned on and the voltage on the high voltage side of the LED load is greater than the supply voltage of the second secondary coil T1-C, the control switch SW is off and is configured to disconnect the high voltage side of the LED load from the wireless module and to prevent the voltage on the high voltage side of the LED load from powering the wireless module. When the wireless module receives a light-off command and the LED load is being turned off (i.e., during a turn-off process of the LED lamp), the wireless module sends a turn-on/connection signal to the control switch SW. The control switch SW is turned on to connect the LED load with the wireless module, and the voltage on the high voltage side of the LED load is supplied to the wireless module. After certain time period since initiating the turn-off process of the LED lamp (e.g., a period to allow the voltage loop to exit saturation and allow the supply voltage of the second secondary coil T1-C to be resumed), the wireless module sends a turn-off/disconnection signal to the switch SW, and the switch SW is disconnected.

FIG. 6 shows a structural diagram of an LED lamp in one embodiment. As shown in FIG. 6, the LED lamp further includes a resistor R, a control switch SW connected in series with the resistor R, and a voltage detecting module for detecting the supply voltage of the second secondary coil T1-C. A first terminal of the control switch SW is connected with the second terminal of the resistor R, and a second terminal of the control switch SW is connected with the wireless module. The control switch SW is configured to turn on or off based on a signal from the voltage detecting module.

Specifically, when the supply voltage of the second secondary coil T1-C detected by the voltage detecting module is less than a first voltage threshold, the control switch SW is turned on (e.g., in response to a connection signal from the voltage detection module), and the voltage on the high voltage side of the LED load powers the wireless module. When the supply voltage of the second secondary coil T1-C detected by the voltage detecting module is greater than a second voltage threshold, the control switch SW is turned off (e.g., in response to a disconnection signal from the voltage detection module). The first voltage threshold is greater than the minimum value of the supply voltage of the second secondary coil. The minimum value of the supply voltage of the second secondary coil may be determined by the power supply requirement of the wireless module in different application scenarios. The second voltage threshold is greater than the first voltage threshold, and the second voltage threshold is less than the voltage of the second secondary coil when the LED load is working, so as to ensure the second secondary coil to power the wireless module when the LED load is turned on.

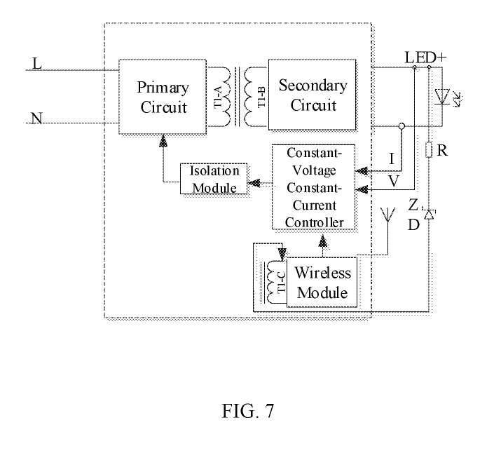

FIG. 7 shows a structural diagram of an LED lamp in one embodiment. As shown in FIG. 7, the LED lamp includes a resistor R and a Zener diode ZD connected in series with the resistor R. A cathode of the Zener diode ZD is connected with the second terminal of the resistor R, and an anode of the Zener diode ZD is connected with the wireless module. The breakdown voltage of the Zener diode ZD is smaller than the voltage difference between the voltage on the high voltage side of the LED load and the supply voltage of the second secondary coil when the LED load is turned off.

Specifically, when the LED load is turned on, the breakdown voltage of the Zener diode ZD is greater than the voltage difference between the voltage on the high voltage side of the LED load and the supply voltage of the second secondary coil. The voltage on the high voltage side of the LED load is not supplied to the wireless module, while the voltage of the second secondary coil is supplied to the wireless module. When the wireless module sends a light-off command and the LED load is turned off, the voltage difference between the voltage on the high-voltage side of the LED load and the supply voltage of the second secondary coil T1-C gradually increases, and the Zener diode ZD breaks down, achieving the outcome that the voltage on the high voltage side of the LED load being supplied to the wireless module for power.

The disclosed embodiments increase the stability of power supply to the wireless module during a turn-off process of the LED lamp and other transient processes by adding a resistance, a control switch, a diode, a Zener diode and/or the like in the common single-stage isolated power supply for the LED lamp and by simple signal control. Because the number of additional devices is small and the additional devices are common, the implementation cost is low.

Finally, it should be noted that the above embodiments are merely illustrative of the technical solutions of the present disclosure, and are not intended to be limited. Although those skilled in the art should understand the details described in the disclosure with reference to the foregoing embodiments, they may modify the technical solutions described in the foregoing embodiments. Or some or all of the technical features may be equivalently replaced. However, these modifications or substitutions do not detract from the essence of the technical solutions of the embodiments.

What is claimed is:

1. An LED lamp, comprising:
one or more LED loads;
a wireless module;
a transformer comprising:
a primary coil,
a first secondary coil configured to power the one or more LED loads of the LED lamp, and
a second secondary coil configured to power the wireless module;
a control switch; and
a resistor, wherein:
the resistor is connected in series with the control switch and then connected in parallel with at least one of the one or more LED loads; and
the wireless module is configured to send a connection signal to turn on the control switch during a turn-off process of the LED lamp.

2. The LED lamp according to claim 1, wherein the resistor is connected in parallel with all of the one or more LED loads, and the control switch is automatically disconnected when being turned on for a preset period of time.

3. The LED lamp according to claim 1, wherein when the control switch is turned on, the resistor is connected in parallel with the at least one of the one or more LED loads, and then connected in series with remaining LED loads of the one or more LED loads.

4. The LED lamp according to claim 1, further comprising:
a constant-voltage controller connected to the wireless module; and
an isolation module connected between the primary circuit and the constant-voltage controller.

5. An LED lamp, comprising:
an LED load;
a wireless module;
a transformer comprising:
a primary coil,
a first secondary coil configured to power the LED load of the LED lamp, and
a second secondary coil configured to power the wireless module; and
a resistor configured to limit a supply current from the transformer during a turn-off process of the LED lamp, wherein a first terminal of the resistor is connected to a high voltage side of the LED load and a second terminal of the resistor is connected to the wireless module.

6. The LED lamp according to claim 5, further comprising:
a diode D, wherein an anode of the diode is connected to the second terminal of the resistor, a cathode of the diode is connected to the wireless module.

7. The LED lamp according to claim 5, further comprising:
a control switch connected in series with the resistor;
a first terminal of the control switch is connected with the second terminal of the resistor, and a second terminal of the control switch is connected with the wireless module;
the control switch is configured to turn on or off based on a control signal from the wireless module; and
the wireless module is configured to send, during a turn-off process of the LED lamp, a connection signal to the control switch to turn on the control switch to connect the LED load and the wireless module.

8. The LED lamp according to claim 7, wherein:
the wireless module is further configured to send, after a preset period since initiating the turn-off process of the LED lamp, a disconnection signal to the control switch to turn off the control switch and disconnect the LED load from the wireless module.

9. The LED lamp according to claim 5, further comprising:
a control switch connected in series with the resistor, a first terminal of the control switch being connected with the second terminal of the resistor, and a second terminal of the control switch being connected with the wireless module; and
a voltage detecting module configured to:
detect a supply voltage of the second secondary coil;
send, when the supply voltage of the second secondary coil is less than a first voltage threshold, a connection signal to the control switch to connect the resistor with the wireless module; and
send, when the supply voltage of the second secondary coil is greater than a second voltage threshold, a disconnection signal to the control switch to disconnect the resistor from the wireless module.

10. The LED lamp according to claim 9, wherein:
the first voltage threshold is less than the second voltage threshold.

11. The LED lamp according to claim 9, wherein:
the first voltage threshold is greater than a minimum value of the supply voltage of the second secondary coil.

12. The LED lamp according to claim 5, further comprising:
a Zener diode connected in series with the resistor, a cathode of the Zener diode being connected with the second terminal of the resistor, and an anode of the Zener diode being connected with the wireless module; and
a breakdown voltage of the Zener diode is greater than a voltage difference between a voltage on the high voltage side of the LED load and a supply voltage of the second secondary coil when the LED load is turned on, and is less than the voltage difference between the voltage on the high voltage side of the LED load and the supply voltage of the second secondary coil when the LED load is turned off.

13. The LED lamp according to claim 5, further comprising:
a constant-voltage controller connected to the wireless module; and
an isolation module connected between the primary circuit and the constant-voltage controller.
